(19) United States
(12) Patent Application Publication
(10) Pub. No.: US 2024/0108012 A1
(43) Pub. Date: Apr. 4, 2024

(54) PORTIONING DEVICE AND METHOD FOR LARGE DOUGH CHUNKS

(71) Applicant: Norman G. Schmidt, Burnaby (CA)

(72) Inventor: Norman G. Schmidt, Burnaby (CA)

(73) Assignee: Food Machinery Engineering LTD., Surrey (CA)

(21) Appl. No.: 18/369,829

(22) Filed: Sep. 18, 2023

Related U.S. Application Data
(60) Provisional application No. 63/407,617, filed on Sep. 16, 2022.

(51) Int. Cl. A21C 5/00; A21C 9/08; A21C 14/00

(52) U.S. Cl. CPC A21C 5/00; A21C 9/08; A21C 14/00

(57) ABSTRACT

A portioning machine reducing bulk semi-viscous material portions to lesser semi-viscous material portions and methods of operating and using are provided. The apparatus includes one or more horizontal conveyor belts with a stream of bulk semi-viscous material portions thereon processing a bulk semi-viscous portion from the stream. Two or more vertical conveyors are provided communicating with an end of the one or more horizontal conveyors and entraining the bulk semi-viscous material portions there between. A portioner sectioner is provided along with a controller, where the controller is adapted to operate the at least one horizontal conveyor to feed and thereby entrain the bulk semi-viscous material in the two or more vertical conveyors, which in turn entrain and pull a lesser portion of semi-viscous material from the bulk semi-viscous material portion and the controller is further adapted to drive the portioner sectioner into the bulk semi-viscous material portion to sever the lesser portion of semi-viscous material portion from the bulk semi-viscous material portion and thereby convey the lesser semi-viscous material portion up the at least two vertical conveyors.

### CROSS-REFERENCE TO RELATED APPLICATIONS

This application claims the priority of U.S. provisional patent application 63/407,617, filed Sep. 16, 2022 (Sep. 16, 2023 being a Saturday), which is incorporated herein by reference.

### BACKGROUND OF THE INVENTION

### Field of the Invention

In the manufacture of, but not limited to, bread and rolls there is a need to take the dough that is fed from the dough feeder which is typically, but not limited to, issuing from a device commonly referred to as a dough chunker and deliver raw dough in sizes of typically, but again not limited to, 60 to 90 pound chunks to the portioning machines. These portions are a bit larger than optimal. It is a principal aspect of this invention to take these larger portions and further cut them so that they would be from about ½ to about ¼ of the larger full sized portions as fed from the portioner. Importantly, accuracy and repeatability in the resulting further portioning must be maintained to provide the necessary accuracy in sub-division of the dough in portions appropriate for the final product, for example but certainly not limited to loaves or sticks of bread.

### Background of the Invention

There exists a need in industry, particularly in the industry of commercial baking, for a continuous flow of smaller or lesser elements of semi-viscous portionable materials, such as and not limited to dough chunks that are often provided in bulk and first sub-divided by a device typically referred to as a chunker. The chunker often breaks down the mixed dough into the larger chunk pieces as noted above. There exists a need in the manufacture of, for instance but certainly not limited to, small bread loaves for the further sub-division of the chunks issued by the chunker. The instant invention provides devices and methods for performing additional reduction of the larger pieces issued by the chunker into smaller or lesser in weight or volume pieces in a consistent and uniform manner that provides higher accuracy in portioning devices and portioning processes.

### SUMMARY OF THE INVENTION

An aspect of the invention is to provide system, devices, articles, and methods for performing additional reduction of the larger pieces issued by the chunker into smaller pieces in a consistent and uniform manner that provides higher accuracy in portioning devices and portioning processes.

An additional aspect of the invention is to provide for a continuous flow of smaller elements of semi-viscous portionable materials, such as and not limited to dough, that are often provided in bulk and first sub-divided by a device typically referred to as a chunker and require further portioning.

A still further aspect of the invention is to provide for a smaller dough portion size that is scalable and related to the proximity of the sub-component parts, including but not limited to an at least two conveyor elements, to adjust the minimum size of the resulting smaller or lesser dough chunks that are further reduced by the instant invention.

The invention includes an article of manufacture, an apparatus, a system, a method for making the article, and a method for using the article.

The apparatus of the invention includes a portioning machine reducing bulk dough portions to lesser dough portions which are fed to a final portioning hopper. The portioning machine having a bulk dough portion hopper, a bulk dough chunker communicating with the bulk dough portion hopper and forming a stream of bulk dough chunks with an at least one horizontal conveyor belt with a stream of bulk dough chunks thereon. An at least two vertical conveyors communicate with an end of the at least one horizontal conveyor and entrain the bulk dough chunk there between. A portioner sectioner is included and a controller is provided wherein the controller is adapted to operate the horizontal conveyor for a period of time to feed the bulk dough chunk to the at least two vertical conveyors and thereby entrain the bulk dough chunk in the at least two vertical conveyors which in turn entrain and pull a lesser portion of the bulk dough chunk from the bulk dough chunk and the controller is further adapted to drive the portioner sectioner into the bulk dough chunk to sever the lesser portion from the bulk dough chunk and thereby convey the lesser portion up the at least two vertical conveyors.

The controller can further include a human interface device. The human interface device can be adapted to enter program variables in the portioning machine. The program variables can include at least one of an at least one time interval to delay or cease operation of the horizontal conveyor, a speed for the at least one vertical conveyor, a speed for at least one of the at least two vertical conveyors, a measure of length representing the distance between the vertical conveyors, and a measure of time representing the frequency of activating the sectioner portioner. The portioning device can further include memory storage, the memory storage storing the variables entered as program variables by the human interface device.

The sectioner portioner can further include an actuator, a guide section, and a blade section, wherein the actuator is in communication with the controller and the controller activates the actuator to drive the guide and thereby the blade section into the bulk dough chunk.

The method of invention includes a method of operating a bulk dough chunk portioning device, including the steps of operating bulk dough chunking machine to provide a stream of bulk dough chunks, conveying on an at least one vertical conveyor a stream of bulk dough chunks, feeding the stream of bulk dough chunks with the at least one horizontal conveyor to at least two vertical conveyors that entrain a lesser portion of a bulk dough chunk from said stream of bulk dough chunks, conveying the lesser dough chunk portion with the vertical conveyors so as to increase the tensile forces on the lesser dough chunk portion and begin separation from the bulk dough chunk, engaging a sectioner portioner to cut the lesser dough chunk portion from the bulk dough chunk portion and releasing the lesser dough chunk portion to the at least two vertical conveyors.

The method can further include ceasing feeding of the bulk dough chunks on the horizontal conveyor. The ceasing of feeding of the bulk dough chunk can occur while the bulk dough chunk is under tensile stretching from the at least two vertical conveyors. The releasing to the at least two vertical conveyor can further include conveying with the vertical conveyors the lesser dough chunk portion to a final portioning device hopper. The method can further include processing the lesser dough chunk with said final portioning device in a commercial baking operation.

The method can further include programming a variable in the portioning device with a human interface device to control the portioning of the lesser dough chunk. The programming of a variable in the portioning device can include programming at least one of an at least one time interval to delay or cease operation of the horizontal conveyor, a speed for the at least one vertical conveyor, a speed for at least one of the at least two vertical conveyors, a measure of length representing the distance between the vertical conveyors, and a measure of time representing the frequency of activating the sectioner portioner. The method can further include storing the programmed variable in a memory or memory storage device.

The apparatus of the invention includes a portioning machine reducing bulk semi-viscous material portions to lesser semi-viscous material portions having an at least one horizontal conveyor belt with a stream of bulk semi-viscous material portions thereon, an at least two vertical conveyors communicating with an end of the at least one horizontal conveyor and entraining the bulk semi-viscous material portions there between, a portioner sectioner and a controller. Wherein the controller is adapted to operate the at least one horizontal conveyor to feed and thereby entrain the bulk semi-viscous material in the at least two vertical conveyors, which in turn entrain and pull a lesser portion of semi-viscous material from the bulk semi-viscous material portion and the controller is further adapted to drive the portioner sectioner into the bulk semi-viscous material portion to sever the lesser portion of semi-viscous material portion from the bulk semi-viscous material portion and thereby convey the lesser semi-viscous material portion up the at least two vertical conveyors.

The controller can further include a human interface device adapted to enter program variables in the portioning machine. The program variables can include at least one of an at least one time interval to delay or cease operation of the horizontal conveyor, a speed for the at least one vertical conveyor, a speed for at least one of the at least two vertical conveyors, a measure of length representing the distance between the vertical conveyors, and a measure of time representing the frequency of activating the sectioner portioner. The portioning device can further include memory storage, the memory storage storing the variables entered as program variables by the human interface device.

The sectioner portioner can further include an actuator, a guide section, and a blade section, wherein the actuator is in communication with the controller and the controller activates the actuator to drive the guide and thereby the blade section into the bulk dough chunk.

Moreover, the above aspects and advantages of the invention are illustrative, and not exhaustive, of those which can be achieved by the invention. Thus, these and other aspects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1 illustrates a side view of an exemplary embodiment of the instant invention in a first position during a portioning process.

FIG. 2 shows a further side view of an exemplary embodiment of the instant invention in a second position during a portioning process.

### DETAILED DESCRIPTION OF THE INVENTION

As noted above, there exists a need in industry, particularly in the industry of commercial baking, for a continuous flow of smaller elements of semi-viscous portionable materials, such as and not limited to dough chunks that are often provided in bulk and first sub-divided by a device typically referred to as a chunker. A non-limiting example of this need is when processing small bread loaves for the further sub-division of the chunks issued by the chunker by a pre-portioning device that feeds a hopper for a final product portioning machine. The instant invention provides devices and methods for performing this additional reduction of the larger pieces issued by the chunker into smaller pieces in a consistent and uniform manner that provides higher accuracy in the feed to portioning devices and portioning processes.

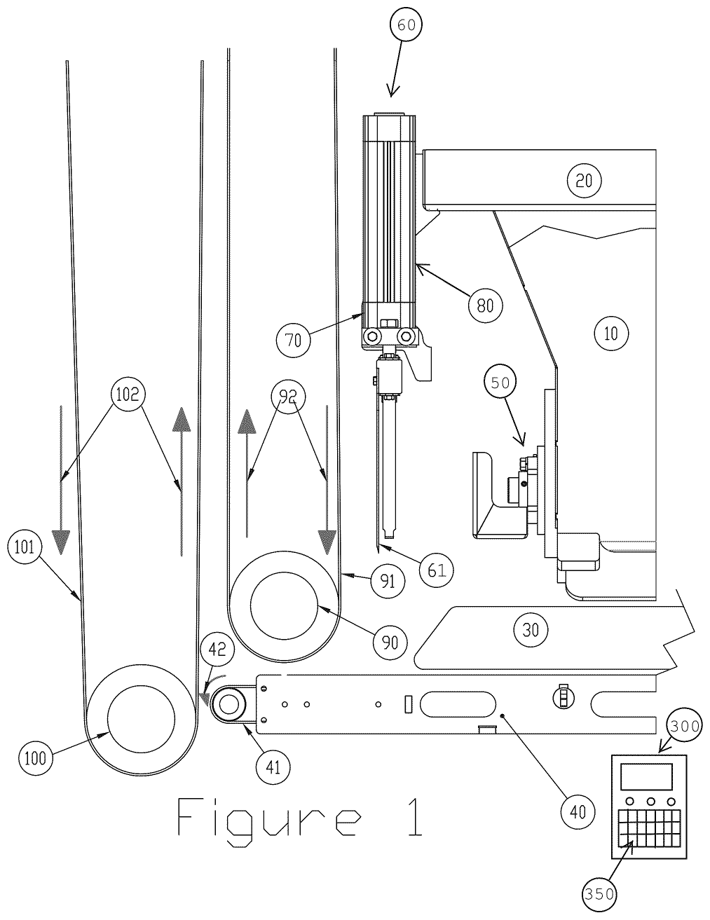

FIG. 1 illustrates a side view of an exemplary embodiment of the instant invention in a first position during a portioning process. A large portioning device typically referred to as a chunker is shown on the right of the drawing having a portioner or chunker assembly 50 coupled to a dough chunker hopper 20 filled with an amount of raw mixed bulk dough 10. A stream of chunked dough or dough chunk 30 is shown issuing from the chunker assembly 50. This figure is of a first position in the machine, prior to separation of the dough chunk 30.

The dough chunk 30 is located on a horizontal conveyor 40 having a horizontal conveyor belt 41, moving the dough chunk 30 from right to left in the figure, as denoted by arrow 42. The chunk is being draw toward a set of at least two vertical conveyors, denoted in the exemplary embodiment as a first vertical conveyor 90 and a second vertical conveyor 100. These are oriented vertically relative to the horizontal conveyor 40. The conveyors 40, 90, 100 are configured so that the horizontal conveyor provides the material to the at least two vertical conveyors which entrain and rapidly remove the dough from the horizontal conveyor and entrain the dough between the respective counter rotating belts of the vertical conveyors after it is further portioned.

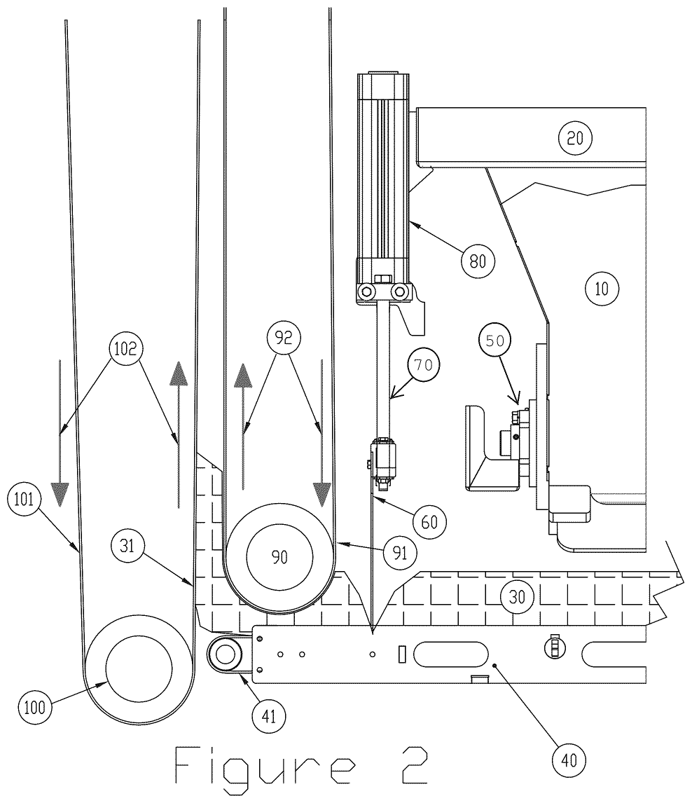

A portioner sectioner 60 is also shown that operates to further portion the dough chunk 30, as better seen in FIG. 2, into a smaller or lesser dough chunk 31. The portioner sectioner 60 has a blade section 61 with a bar or guide 70 which is not shown in FIG. 1 as it is retained within an actuator 80. When called upon to activate the portioner sectioner 60, the actuator 80 will receive an instruction from a controller 300 and drive the guide 70 downward with portioner section blade section 61 into the dough, as more clearly shown in FIG. 2 of the exemplary embodiment. In further embodiments, variations on the sectioner are contemplated, for instance utilizing a timing device or similar analog system for driving the portioner sectioner or similarly utilizing an electrically driven blade across the chunk. These variations and others like them being embraced in the spirit of the invention and being well understood by one of ordinary skill in the art as variations on devices to section dough accurately.

FIG. 2 shows a further side view of an exemplary embodiment of the instant invention in a second position during a portioning process. In this position the portioner sectioner 60 has been engaged to section a portion of the larger dough chunk 30 into a smaller dough chunk 31. In this instance, the large dough chunk 30 has been entrained by the at least two vertical conveyors 90,100 and is being drawn or entrained between the vertical conveyors 90,100 as shown. This pulls on the dough creating a tensile force within the dough chunk 30. Simultaneously, the controller 300 using variable inputs programmed through a human device interface (HDI) 350, here shown as a keypad and display, pauses the forward motion of the horizontal conveyor 40. This enhances the tensile draw on the dough, which is semi-elastic in nature and begins to stretch and tear in a predictable fashion.

Based on the programmed variables, the timing of the activation of the portioner sectioner 60 is controlled by the controller 300 and deploys at the desired moment to section the large dough chunk 30 into the smaller dough chunk 31. The controller 300 activates the actuator 80 driving he guide 70 down and thrusting the blade section 61 into the large dough chunk 30 to separate smaller dough chunk 31 which is being taken up by the at least two vertical conveyors 90, 100, as shown.

It can be desirous to take the dough chunker dough chunk 30 and take it from where it will have a weight of 60 to 90 pounds and cut it into smaller portions 31 so as to feed into a portioning machine hopper (not shown) further down stream in the forming process. This feeding of smaller dough portions 31 is more beneficial than the feeding of full sized dough chunks 30, as the larger portions can tend to create stagnant dough that will adhere to the sides of the dough portioning machine hopper sidewalls. Additionally, the larger dough portions can cause large fluctuations in the dough height within the portioning machine hopper, the weight of which varies by the size of the portions fed to it. This in turn can result in portioning deviations due to the fluctuations caused by the changing dough heights in the portioning machine hopper and the pressure applied by the height of the dough in that hopper. Smaller portions provide more accurate portioning from the portioning hopper by making the variations in the downward force from the weight of dough in the hopper smaller as the weight for each smaller portion is less and the variations in the flow and thereby the height in the hopper more easily controlled. In other words, rather than replenishing the hopper with about, for example, sixty to ninety pound portions, the smaller portions can be provided at much smaller increments in a controlled fashion and reduce the weight of the weight being resupplied.

In operation, as seen in FIGS. 1 and 2, a mix of raw bulk dough 10 will be in, but is not limited to being contained in, the dough chunker hopper 20. The dough chunker will operate and deposit a larger dough chunk 30 onto the lower conveyor 40 of the chunker where the lower dough conveyor belt 41 will move forward with the dough as a stream or large chunk 30. This lower conveyor 40 feeds moves the dough chunk thirty toward an at least two vertical conveyors, in the embodiment shown towards the first vertical conveyor 90 where the combination of the lower conveyor belt 41 movement and the engagement of the dough to the first vertical conveyor belt 91 will further entrain and encourage the dough chunk 30 to further engage or come in contact with the second vertical conveyor belt 101 of the second vertical conveyor 100. Once the dough chunk 30 is engaged by the at least two conveyors, herein the first vertical conveyor 90 and corresponding first vertical conveyor belt 91 and second vertical conveyor 100 and corresponding second vertical conveyor belt 101 the lower conveyor belt 41 may stop and in doing so with both the first vertical conveyor 90 and second vertical conveyor 100 and the respective conveyor belts 91 and 101, the movement will continue to pull on the dough chunk 30 stream inducing a tensile stress In the dough chunk 30 whereby when the dough portioner sectioner 60 can then come down on the stretching dough chunk 30.

This stretching action of the dough chunk 30 plus the action of the dough portioner sectioner 60 will cause a severing or cutting action of the dough chunk 30 where the portion of the dough that is entrained and pulled by the first vertical conveyor belt 91 and second vertical conveyor belt 101, in this non-limiting example, will cause a portion of the dough chunk 30 to sever and be carried up from the larger dough chunk 30 between the at least two vertical conveyors 90,100. Depending on the time that the lower conveyor belt 41 is stopped while the vertical conveyor belts 91, 101 continue to travel this will determine or create the size of the gap between the end of the newly created smaller chunk 31 and the larger dough chunk 30 from which the smaller dough chunker 31 portion has been severed.

This results in the smaller dough chunk 31 desired in the instant invention. The initial tensile stress in the dough chunker 30 will cause the severing of the dough chunk 30 to pull away from the dough portioner sectioner 60 so that the dough chunk is clear of the dough portioner sectioner 60. This action ensures that the dough chunk 30 will pull away from the dough portioner sectioner cleanly and clear the path of advance for the following pieces. In addition, to aid in the release of the smaller portion, the portioner sectioner 60 is typically, but is not limited to being, coated with a non stick or reduced adhesion material such as but not limited to Teflon or it can be of a polymer material that has low cohesion to dough as a property as non-limiting examples of such coatings.

The directions of travel of the at least two vertical conveyor belts and the horizontal conveyor belt travel are shown for clarity but it should be apparent to a person skilled in the art that from the description that this would be the required direction of belt travel so as to take the dough 10 from the dough chunker hopper to the first vertical conveyor 91 and second vertical conveyor 101 as seen in the non-limiting exemplary embodiment. The first vertical conveyor 90 has a direction of travel 92 and second vertical conveyor belt 100 has a direction of travel 102. Finally lower conveyor belt 40 direction of travel is show as 42. It being well understood that variations to achieve similar directional pulling and potential for severing of the dough chunk 30 into accurately portioned smaller chunks 32 is would be well understood by one of ordinary skill in the art, for instance mirroring the lower conveyor 42 in the FIG. 1-2 such that it moves from right to left without departing from the spirit of the invention and such a modification would be evident to one of ordinary skill in the art based on the disclosure of the instant invention.

A controller 300 is provided to control, at least in part, the timing of the pause of the lower conveyor 40, the operation and timing of the drop of the portioner sectioner 60, the speed and spacing of the at least two vertical conveyors, and other variables that determine the portion size and/or weight of a particular product. These variables can be varied and/or initially programmed by a user utilizing a human user interface (HMI) 350. Similarly the variables can be stored in memory (not shown), for instance on the controller 300 or externally on a memory stick, for convenience and improved setup times.

The exemplary embodiment of the instant invention is typically installed in a particular site and this in effect governs an important aspect as to the range of possible smaller dough portions 31 that can be produced. The proximity of the first vertical conveyor 91 and the second vertical conveyor 111 to the dough portioner sectioner 60 is relevant to achievable the size of smaller dough portions 31. If this distance is as short as possible, it will provide for the largest available range of smaller portion size 31 and also potentially deliver the smallest portion size 31 possible. It will also aid in other aspects regarding accuracy and handling of the portioned dough, as discussed herein below. Thus, it as a component of the method of installation and operation of the instant invention that the geometry of the components be considered and can be included as a component of the variables programmed into the device.

Increasing the distance from the dough portioner sectioner 60 to the vertical conveyor belts 91 and 111 will increase the minimum portion size of the smaller dough chunks 31. If one has as short as distance as possible but wants to have larger portions this is still well within the range of operation as it just means that the combination of lower conveyor belt 41 and the at least two vertical conveyor belts, shown as first vertical conveyor belt 91 and second vertical conveyor belt 101 in the exemplary embodiment, will run for a longer period of time, running more dough out and up. However, if shorter pieces are desired, the minimum distance between the vertical conveyors 90, 100 and the portioner sectioner 60 dictates that size. The system cannot cut smaller sections than this distance, effectively operating with zero stop timing for the lower conveyor 40 as outlined above, the portion is cut as it is immediately entrained by the vertical conveyors 90, 100.

The other result of increased distance from dough portioner sectioner 60 to the at least two vertical conveyors 90, 100 is that the dough stream of chunk 30 will be pulled for an extended or further distance beyond a minimum possible distance, where the dough can have a tendency to adhere to the lower conveyor belt 41 when so stretched or tearing, which could give small dough chunk portions 31 that can be incomplete or given too odd size variations and or bonded to other smaller dough portions 31.

It should be apparent to those skilled in the art that changes in the parts and operation, such as but not limited to, the style or type of dough portioner sectioner 60 or the type of linear actuator can be changed for instance, but again certainly not limited to, changes in dough style, leading edge profile and materials and/or the type of controller used and or type of linear actuator without departing from the novelty and or spirit of the invention.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. can be present without falling outside the scope of the corresponding claim or recitation. As used herein, when the phrase “at least” is used as the transition term in, for example, a preamble of a claim, it is open-ended in the same manner as the term “comprising” and “including” are open ended.

To the extent that process are indicated, the relative order and execution to the process is non-limiting in its explanation as an example and additional steps or process can be included in the overall process without departing from the spirit of the invention whilst reading on to the steps enumerated in the claims of the invention, as would be understood by one of ordinary skill in the art of the invention.

The embodiments and examples discussed herein are non-limiting examples. The invention is described in detail with respect to preferred embodiments, and it will now be apparent from the foregoing to those skilled in the art that changes, and modifications can be made without departing from the invention in its broader aspects, and the invention, therefore, as defined in the claims is intended to cover all such changes and modifications as fall within the true spirit of the invention.

What is claimed is:

1. A portioning machine reducing bulk dough portions to lesser dough portions which are fed to a final portioning hopper, the portioning machine comprising:
a bulk dough portion hopper;
a bulk dough chunker communicating with the bulk dough portion hopper and forming a stream of bulk dough chunks;
an at least one horizontal conveyor belt with the stream of bulk dough chunks thereon;
an at least two vertical conveyors communicating with an end of the at least one horizontal conveyor and entraining a bulk dough chunk from the stream of bulk dough chunks there between;
a portioner sectioner; and
a controller, wherein the controller is adapted to operate the horizontal conveyor for a period of time to feed the bulk dough chunk to the at least two vertical conveyors and thereby entrain the bulk dough chunk in the at least two vertical conveyors which in turn entrain and pull a lesser portion dough chunk from the bulk dough chunk and the controller is further adapted to drive the portioner sectioner into the bulk dough chunk to sever the lesser portion dough chunk from the bulk dough chunk and thereby convey the lesser portion dough chunk up the at least two vertical conveyors.

2. The portioning device of claim 1, wherein the controller further comprises a human interface device.

3. The portioning device of claim 2, wherein the human interface device is adapted to enter program variables in the portioning machine.

4. The portioning device of claim 3, wherein the program variables include at least one of an at least one time interval to delay or cease operation of the horizontal conveyor, a speed for the at least one vertical conveyor, a speed for at least one of the at least two vertical conveyors, a measure of length representing the distance between the vertical conveyors, and a measure of time representing the frequency of activating the sectioner portioner.

5. The portioning device of claim 4, further comprises a memory storage, the memory storage storing the variables entered as program variables by the human interface device.

6. The portioning device of claim 1, sectioner portioner further comprises an actuator, a guide section, and a blade section, wherein the actuator is in communication with the controller and the controller activates the actuator to drive the guide and thereby the blade section into the bulk dough chunk.

7. A method of operating a bulk dough chunk portioning device, comprising:
operating bulk dough chunking machine to provide a stream of bulk dough chunks;
conveying on an at least one vertical conveyor a stream of bulk dough chunks;
feeding the stream of bulk dough chunks with the at least one horizontal conveyor to at least two vertical conveyors that entrain a lesser portion of a bulk dough chunk from said stream of bulk dough chunks;
conveying the lesser dough chunk portion with the vertical conveyors so as to increase the tensile forces on the lesser dough chunk portion and begin separation from the bulk dough chunk;
engaging a sectioner portioner to cut the lesser dough chunk portion from the bulk dough chunk portion; and
releasing the lesser dough chunk portion to the at least two vertical conveyors.

8. The method of claim 7, further comprising ceasing feeding of the bulk dough chunk on the horizontal conveyor.

9. The method of claim 8, wherein the ceasing of feeding of the bulk dough chunk occurs while the bulk dough chunk is under tensile stretching from the at least two vertical conveyors.

10. The method of claim 7, wherein the releasing to the at least two vertical conveyor further comprises conveying with the vertical conveyors the lesser dough chunk portion to a final portioning device hopper.

11. The method of claim 10, further comprising processing the lesser dough chunk with said final portioning device in a commercial baking operation.

12. The method of claim 7, further comprises programming a variable in the portioning device with a human interface device to control the portioning of the lesser dough chunk.

13. The method of claim 12, wherein the programming of a variable in the portioning device includes programming at least one of an at least one time interval to delay or cease operation of the horizontal conveyor, a speed for the at least one vertical conveyor, a speed for at least one of the at least two vertical conveyors, a measure of length representing the distance between the vertical conveyors, and a measure of time representing the frequency of activating the sectioner portioner.

14. The method of claim 13, further comprises storing the programmed variable in a memory or memory storage device.

15. A portioning machine reducing bulk semi-viscous material portions to lesser semi-viscous material portions comprising:
an at least one horizontal conveyor belt with a stream of bulk semi-viscous material portions thereon;
an at least two vertical conveyors communicating with an end of the at least one horizontal conveyor and entraining the bulk semi-viscous material portions there between;
a portioner sectioner; and
a controller, wherein the controller is adapted to operate the at least one horizontal conveyor to feed and thereby entrain the bulk semi-viscous material in the at least two vertical conveyors, which in turn entrain and pull a lesser portion of semi-viscous material from the bulk semi-viscous material portion and the controller is further adapted to drive the portioner sectioner into the bulk semi-viscous material portion to sever the lesser portion of semi-viscous material portion from the bulk semi-viscous material portion and thereby convey the lesser semi-viscous material portion up the at least two vertical conveyors.

16. The portioning device of claim 15, wherein the controller further comprises a human interface device adapted to enter program variables in the portioning machine.

17. The portioning device of claim 16, wherein the program variables include at least one of an at least one time interval to delay or cease operation of the horizontal conveyor, a speed for the at least one vertical conveyor, a speed for at least one of the at least two vertical conveyors, a measure of length representing the distance between the vertical conveyors, and a measure of time representing the frequency of activating the sectioner portioner.

18. The portioning device of claim 17, further comprises a memory storage, the memory storage storing the variables entered as program variables by the human interface device.

19. The portioning device of claim 1, wherein the sectioner portioner further comprises an actuator, a guide section, and a blade section, wherein the actuator is in communication with the controller and the controller activates the actuator to drive the guide and thereby the blade section into the bulk dough chunk.
